(19) United States
(12) Patent Application Publication
(10) Pub. No.: US 2004/0011711 A1
(43) Pub. Date: Jan. 22, 2004

(54) Method of processing reject mailpieces using voice recognition and a mail sorting apparatus

(75) Inventors: John H. Steinmetz, Bridgeport, CT (US); James Giordano, Danbury, CT (US); Robert K. Gottlieb, Milford, CT (US); Joseph D. Mallozzi, Trumbull, CT (US); William E. Ryan, Monroe, CT (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT

(21) Appl. No.: 10/020,650

(22) Filed: Oct. 30, 2001

(51) Int. Cl. B07C 5/00

(52) U.S. Cl. 209/546

(57) ABSTRACT

An embodiment of the present invention comprises a mailpiece sorting apparatus including a voice recognition system and a method of processing reject mailpieces using voice recognition. Mailpieces that OCR cannot read and determine the recipient for (“rejects”) are processed. The operator obtains a reject and determines the proper address segment for the recipient information. The proper address segment is spoken by the operator to the recognition system. The voice recognition software interprets the information and communicates it to recipient matching software. The software narrows the potential recipient matches in the mailpiece sorting apparatus addressee database. If a match is made, the operator is prompted to place the mailpiece onto mailpiece sorting apparatus which sends the mailpiece to the proper sort bin based on addressee identification performed by the matching software. The present invention may also calculate statistical information regarding reject mailpieces.

### FIELD OF THE INVENTION

The invention disclosed herein relates generally to automated mail sorting and more particularly, a method of processing rejected mail using an automated mailpiece sorting apparatus with integrated voice recognition.

### BACKGROUND OF THE INVENTION

The processing and handling of mailpieces consumes an enormous amount of human and financial resources, particularly if the processing of the mailpieces is done manually. The processing and handling of mailpieces not only takes place at the Postal Service, but also occurs at each and every business or other site where communication via the mail delivery system is utilized. That is, various pieces of mail generated by a plurality of departments and individuals within a company need to be addressed, collected, sorted and franked as part of the outgoing mail process. Additionally, incoming mail needs to be collected and sorted efficiently to ensure that it gets to the addressee (i.e. employee or department) in a minimal amount of time. Since much of the documentation and information being conveyed through the mail system is critical in nature relative to the success of a business, it is imperative that the processing and handling of both the incoming and outgoing mailpieces be done efficiently and reliably so as not to negatively impact the functioning of the business.

Various automated mail handling machines have been developed for processing incoming mail (removing individual pieces of mail from a stack and performing subsequent actions on each individual piece of mail). Generally, the mail handling machines separate individual mailpieces from a stack, read the mailpieces using an optical character recognition (OCR) system and compare the read information to an addressee database in order to determine the appropriate destination points for delivery of the mailpieces. Some of the incoming mail received at a mailroom of the company can be unreadable by the OCR system, the quantity of which can be great since recipients cannot control the addressee format in which the incoming mail is received. Some of the unreadable mail could be, for example, mail which is not OCR readable “OCR rejects” (i.e. smeared or needs to be opened to determine addressee), “mystery mail” which mail with no particular addressee (i.e. mail addressed to a company or department only or mail with poor quality handwriting), or “research mail” (i.e. mail that can not be read by OCR but does not require opening for the operator to determine the addressee, including the situation where there are several potential addressees with the same name). The unreadable mail, which will be referred to generally as “reject mail” is expensive to process since it drains the resources of the mail room requiring additional time and labor for sorting and delivery. Therefore, it would be helpful if the mailpieces which are not automatically readable can be processed as quickly as possible.

Previously, if a determination could not be made by the incoming mail handling machine as to the addressee, a video image of the mailpiece was viewed by an operator and in the case where the addressee image was readable by the operator, addressee information was keyed into the system and associated with an identification number for the mailpiece. This is typically done after the unreadable mailpieces are sorted into a reject bin because it requires time to make the determination and provide the information to the system for proper sorting. The previously rejected mailpieces are then resorted by reading the identification information which can be printed on the mail during the first sort. The identification information is linked with the addressee information manually keyed in by the operator during the reject processing/video coding sequence is used to sort the mailpiece to the proper destination bin.

Video processing of mailpieces has been performed at an on-site video coding terminal or off-site video coding facility where the video image is transmitted for determination of addressee by an operator. The information is then transferred back to the sorting apparatus. The software and hardware costs associated with video processing can be high because video coding requires additional computer systems, image servers and workstations. Additionally, licensing fee for video coding software can be expensive. Video coding can also be labor intensive because the operator has to input information using a keyboard. While predictive keying can be used, the operator is still bogged down with using his or her hands to input addressee information. Thus, a separate video coding operator is needed in apart from the incoming mailpiece sorting apparatus operator in order to keep throughput on the sorting apparatus while processing rejects. Thus one of the problems of the prior art is that a system is not available for quickly processing unreadable mailpieces. Another problem of the prior art is that a system is not available which produces higher throughput. Another problem of the prior art is that is can be expensive. Yet another problem of the prior art is that incoming mail handling machines do not include integrated reject processing. Therefore, a method of processing unreadable mailpieces is needed which integrates reject processing with the incoming mailpiece sorting apparatus at lower cost and with greater throughput.

### SUMMARY OF THE INVENTION

This invention overcomes the disadvantages of the prior art by providing a method of processing reject mailpieces with better throughput and lower cost. This in turn affords quicker mailpiece processing. The present invention is directed to, in general, automated mail sorting and more particularly, a method of processing rejected mail using an automated mailpiece sorting apparatus with integrated voice recognition for reject processing. An operator reads addressee information on rejected mailpieces into the voice recognition system and places the mailpiece into the mailpiece sorting apparatus feed path for appropriate sorting.

The mailpiece sorting apparatus may generally comprise a feeder, a scanner, a mailpiece deliverer, a bin module with compartments or bins for receiving sorted mailpieces, optical character recognition system (OCR) for reading addressee information, a personal computer (PC) or microprocessor based system, recipient matching software and an addressee database. The mailpiece sorting apparatus of the present invention also comprises a voice recognition system.

In an embodiment of the present invention, mailpieces are sorted by the mailpiece sorting apparatus during a first-pass sort (i.e. on first pass mailpieces are divided into available bins, on next pass, mailpieces from one bin of the first pass are resorted into available bins). Mailpieces that can be read properly by the mailpiece sorting apparatus OCR system are sent to their designated sort bins. Mailpieces that the mailpiece sorting apparatus OCR system cannot read and determine the recipient for (“rejects”) are sent to a reject bin. Once the first pass sorting is completed, the rejects are processed using a reject sorting mode.

During the reject sorting mode, the feeder of the mailpiece sorting apparatus can be set to manual feed. This allows the operator to manually or hand feed individual mailpieces into the mailpiece sorting apparatus. A voice recognition software system which enables mailpiece addressee look-up is also activated. The operator obtains an reject and determines the proper address segment for the recipient information. This proper address segment could be, for example, the addressee last name, mail stop, department, building, or company. The characters for the proper address segment are spoken by the operator one at a time (single character input) into a microphone 109 connected to voice recognition software. The voice recognition software interprets the characters and communicates the characters to recipient matching software. Alternatively, the operator could speak entire words identifying the addressee; this alternative could use voice recognition software programmed for name recognition rather than dictionary word (letter-by-letter) recognition.

Using the single character input embodiment, as each character is input into the voice recognition system, the voice recognition system narrows down the list of potential recipient matches in the mailpiece sorting apparatus addressee database. This continues until a single recipient is identified or no match can be made. If a match is made, the operator is given a visual or audio prompt to place the mailpiece into the mailpiece sorting apparatus feeder. The mailpiece sorting apparatus sends the mailpiece to the proper sort bin based on the addressee identification performed by the matching software. If the recipient could not matched via the spoken characters, the operator is given a different visual or audio prompt by the mailpiece sorting apparatus and sets the piece aside for later disposition. An additional feature of the present invention tracks and calculates statistical information regarding the different types of rejects and the total number of rejects as compared to the total number of mailpieces sorted. The mailpiece sorting apparatus could generate report(s) detailing counts of the different types of rejects as well as operator productivity measurements. In an alternate embodiment some of the rejects may be processed without further sorting by the mailpiece sorting apparatus.

If the rejects that were corrected by spoken characters require further sorting passes after the voice entry processing, additional operations are needed to store the recipient information for the piece. During the first sort pass when the rejects are identified and collected, a bar code identification (ID) is printed on mailpieces that cannot be read by the OCR. The bar code data is unique to each piece. When the operator single feeds each rejected mailpiece after performing the voice entry correction described above, the mailpiece sorting apparatus OCR system reads the bar code ID on the mailpiece. The mailpiece bar code ID is then stored in conjunction with the recipient information from the recipient matching software in a special bar code ID/recipient file. The next time the mailpiece is sorted, the bar code ID is read instead of the mailpiece address. The bar code ID is used to find the proper mailpiece recipient in the bar code ID/recipient file. Based on the recipient found in the file, the mailpiece is sent to the proper sort bin.

An advantage of the method of the present invention is that it provides higher throughput with minimal additional hardware and software costs. Another additional advantage of the present invention is that there is higher throughput of sorted mailpieces. Another advantage of the present invention is that it allows for reject processing without typing skills necessitated for video coding. Other advantages of the invention will in part be obvious and will in part be apparent from the specification. The aforementioned advantages are illustrative of the advantages of the various embodiments of the present invention.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is a block diagram that illustrates a computer system upon which an embodiment of the invention may be implemented.

FIG. 2a illustrates the connection of the computer system to the sorting apparatus.

FIG. 2b is a block diagram illustrating a four bin module which may be part of the mailpiece sorting apparatus which is used to perform a method of the present invention.

FIGS. 3a-3d illustrate various reject mailpieces.

FIGS. 4a-b is a flowchart of an embodiment of the method of processing unreadable mailpiece(s) in a single sort pass scenario.

FIGS. 5a-c is a flowchart of an embodiment of the method of processing unreadable mailpiece(s) in a multiple sort pass scenario.

### DETAILED DESCRIPTION OF THE PRESENT INVENTION

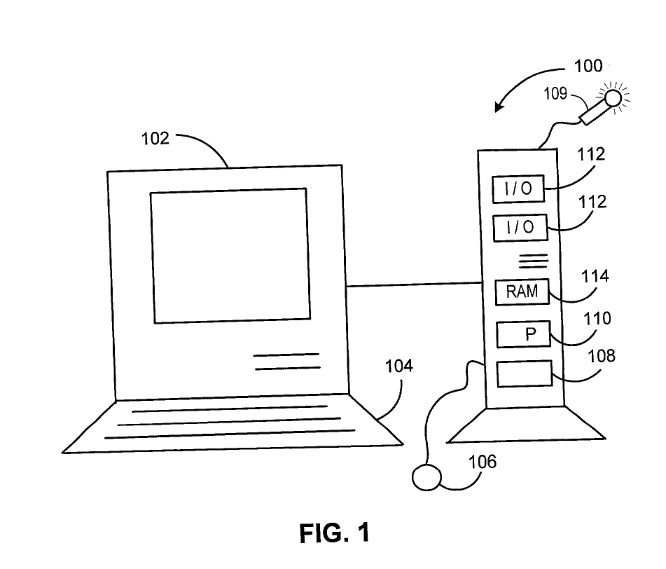

In describing the present invention, reference will be made herein to FIGS. 1-5 of the drawings in which like numerals refer to like features of the invention. Features of the invention are not necessarily shown to scale in the drawings.

Hardware Overview

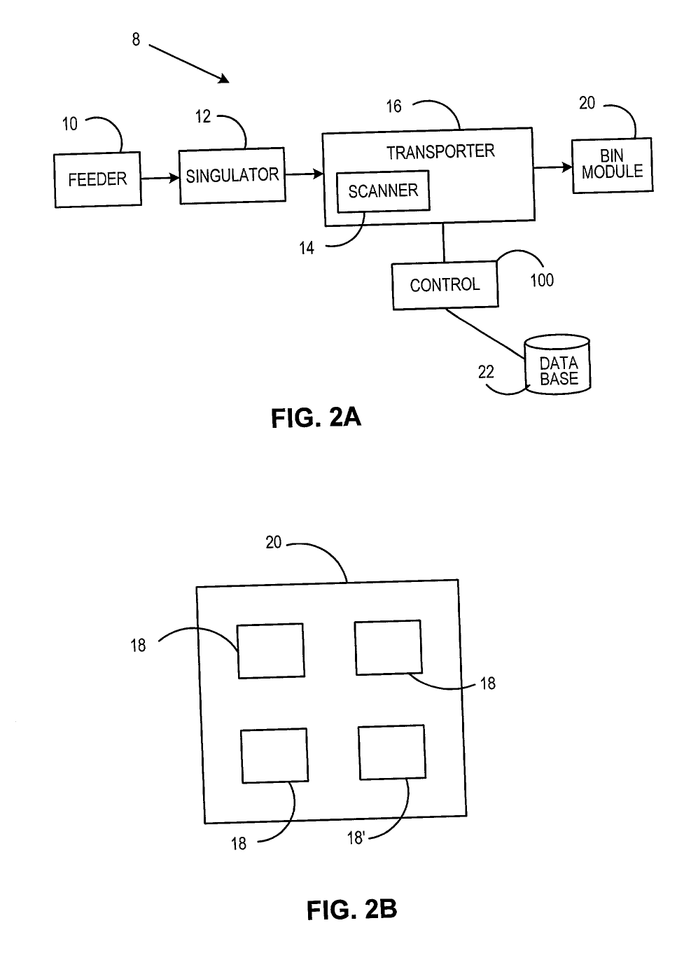

FIG. 1 is a block diagram that illustrates a computer system 100 upon which an embodiment of the invention may be implemented. Computer system 100 may be a personal computer which is used generically and refers to present and future microprocessing systems with at least one processor operatively coupled to user interface means, such as a display 102 and keyboard 104, and/or a cursor control, such as a mouse or a trackball 106, and storage media 108. An input device such as a microphone 109 can be included for use as a voice data input in conjunction with a voice recognition system (note shown). The voice recognition system may comprise the computer system 100, voice recognition software (note shown) such as, for example, DRAGON NATURALLYSPEAKING®, the microphone 109 and usually a sound card (not shown). The voice recognition system can be used in conjunction with the address database 22 (shown in FIG. 2) and recipient matching software (not shown). The personal computer 100 may be a workstation that is accessible by more than one user. The personal computer also includes a conventional processor 110, such as a Pentium® microprocessor manufactured by Intel, and conventional memory devices such as hard drive 108, floppy drive(s) 112, and memory 114.

The computer system 100 can be connected to a sorting apparatus 8 as illustrated in FIG. 2a. The mailpiece sorting apparatus 8 may generally comprise a feeder 10, a line scan camera 14 (and OCR software, not shown), a mailpiece transporter 16, a bin module 20 (shown in FIG. 2b) with compartments or bins 18, 18′ for receiving sorted mailpieces 30 and a control system 24 which may be the microprocessor based personal computer system 100 described above. The computer system 100 can run the voice recognition software. The computer system 100 includes appropriate memory devices 108, 114 for storage of information such as an address database 22. One of ordinary skill in the art would be familiar with the general components of the sorting apparatus upon which the method of the present invention may be performed.

The mailpiece sorting apparatus 8 and the OCR software may be used to determine the addressee of the mailpiece 30 or other information on the face of the mailpiece 30. The reading of various information may be performed with the assistance of intelligent character recognition (ICR) or imaging and character recognition (OCR/IC) which may be part of the above mentioned OCR software and can read the various fields on the mailpiece 30. The microphone 109 and voice recognition software can be used for operator input of addressee information from the face of the mailpiece 30, such as in the case of reject processing.

Reject Mailpieces

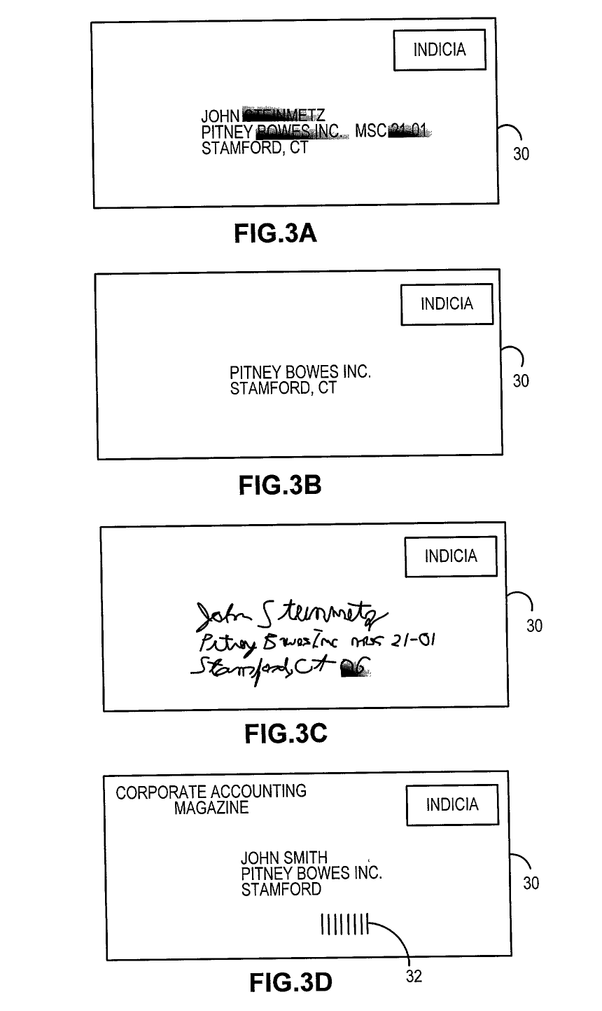

FIGS. 3a-3d illustrate various reject mailpieces 30. FIG. 3a is an example of a reject mailpiece 30 which is unreadable by the OCR system because the addressee information is smeared (“OCR reject”). In some instances, the addressee information can be smeared to the point where the operator would need to open the mailpiece 30 to determine the addressee. FIG. 3b is an example of a reject mailpiece 30 for which the intended individual addressee cannot be determined from the face of the mailpiece 30 because there is no individual addressee but rather a general address to the company, as in this example, Pitney Bowes Inc. (“mystery mail”). In the case of the mystery mail of FIG. 3b, the mailpiece 30 would need to be opened to determine the appropriate addressee. In another example, not shown, the mailpiece 30 could be addressed to a company and/or department and would need to be opened to determine the appropriate addressee.

FIG. 3c is an example of mystery mail for which the intended individual addressee cannot be determined using OCR because the handwriting in the addressee segment is unreadable by the OCR (“mystery mail”). It should be noted that while some handwriting is readable by OCR systems, not all handwriting is automatically readable, especially handwriting where the character shapes are of poor quality and are poorly spaced such as, for example, some cursive writing as is illustrated on mailpiece 30 in FIG. 3c.

FIG. 3d is an example of a reject mailpiece 30 for which the operator can determine the appropriate addressee from the face of the mailpiece 30 (without opening the mailpiece 30) but for which the OCR system could not determine the appropriate addressee (“research mail”). In the example of FIG. 3d, the addressee database 22 contains two addressees named John Smith. The operator may be able to determine the appropriate addressee by reading the return address information. For example John Smith in accounting might get mail with a return address of a corporate accounting magazine, whereas John Smith of legal might get mail with a return address of a corporate counsel society. Thus, the mailpiece of FIG. 3d would be routed to John Smith of accounting and such information would be input by the operator using the voice recognition system.

The present invention is related to the use of computer system 100 connected to the mailpiece sorting apparatus 8 for performing application software methods. The method of the present invention is used to process mailpieces 30 which are unreadable by the OCR system (“reject” mailpieces).

Voice Recognition Reject Processing

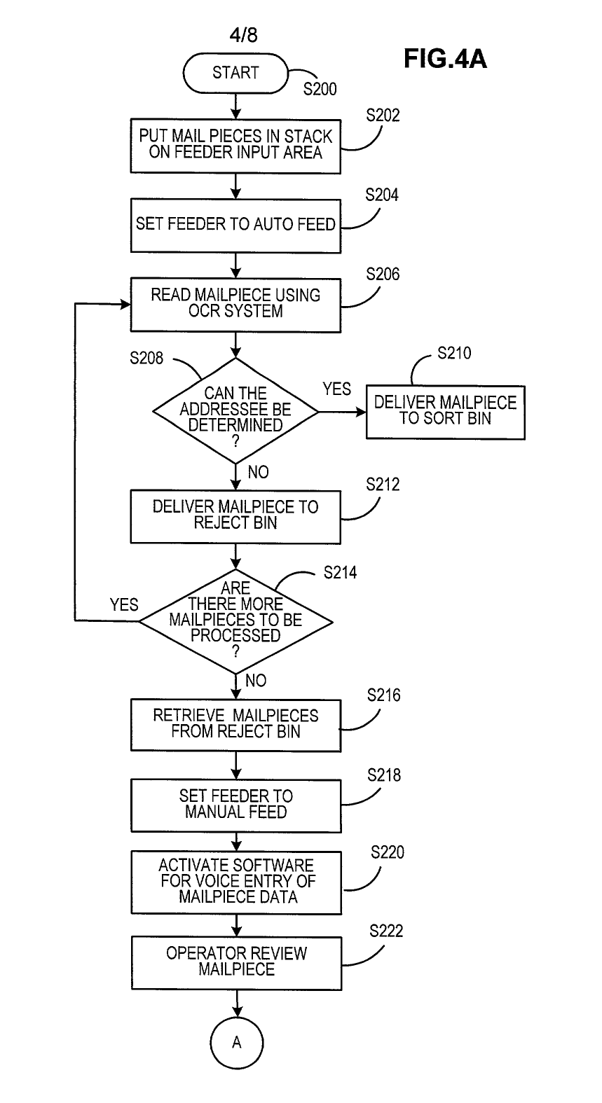

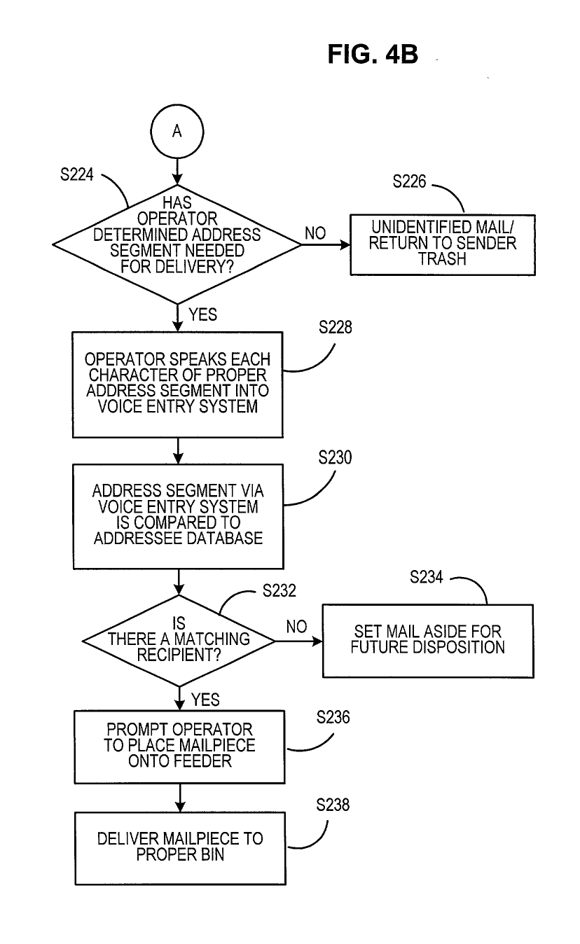

FIGS. 4a-b is a flowchart of an embodiment of the method of processing unreadable mailpieces in a single sort pass scenario. At step S200 the method begins. At step S202 a stack of mailpieces (not shown) is placed on the feeder 10 of the mailpiece sorting apparatus 8. At step S204 the feeder 10 is set to auto feed. At step S206 the mailpieces 30 are read using the OCR system. At step 208 a query is made as to whether the addressee can be determined from the information read by the OCR system. If the answer to the query S208 is yes, then the mailpiece 30 is delivered to the appropriate sort bin 18 at step S210. If the answer to the query S208 is no, then the mailpiece 30 is delivered to a reject bin 18′ at step S212. Next, a query is made at step S214 as to whether there are additional mailpieces 30 to be processed. If the answer to the query of step S214 is yes, then steps S206 through S214 are performed until no mailpieces 30 are left to be processed. It the answer to the query at S214 is no, then the process proceeds to step S216 and the mailpieces 30 are retrieved from the reject bin 18′. At steps S218 and S220, the feeder 10 is set to manual feed, and the voice recognition software is activated, respectively. At step S222 the operator reviews mailpieces 30 to determine the appropriate addressee. This step can entail reading the addressee information from the front of the mailpiece 30, opening the envelope to determine the proper addressee or making a researched determination of the addressee by information contained on or within the mailpiece 30. At step S224 a query is made as to whether the operator has determined the address segment needed for delivery. If the response to the query S224 is no, then at step S226 the mailpiece 30 is placed in an area designated for unidentifiable recipient mailpieces 30.

If the response to the query S224 is yes, then the operator speaks addressee information into the voice recognition system of the mailpiece sorting apparatus 8 at S228. The operator may speak a single character at a time or alternately may speak entire words at a time. The input by the operator is dependent upon the technology of the voice recognition software package that is used. For example, “discrete speech” software can be used to input information on a word-by-word basis, or continuous speech software can be used to input information that is spoken the way people usually speak- in fluent sentences. Generally, the voice recognition software comprises three parts: 1) a large electronic dictionary (e.g., such as Merriam-Webster); 2) a smaller active dictionary that reflects the user's own usage (i.e. words in the addressee database 22); and 3) a voice model. The voice model system, also called “speaker dependent” or “speaker independent”. Speaker dependent systems can be used by individual speakers where the system is trained to recognized the speaker(s)' voice(s). Speaker independent systems have high recognition rates without training the system to recognize individual speakers voices. The type of voice recognition system used is dependent upon the features desired and the cost of the system. Low cost systems can be obtained for use in conjunction with mail sorting apparatus 8.

Returning to the flow chart of FIGS. 4a-4b, the address segment input into the voice entry system is compared to the addressee database 22 at S230. The type of comparison performed by this step is dependent upon the type of voice recognition system that is being used. For example, if the operator is inputting a single character at a time into the voice system, the system may check for a matching addressee after each character is input. If the operator is inputting entire words at one time, the system may check for a matching addressee after each word is input. As is in the case of a single character input system, the operator picks up a new reject and determines the proper address segment for the recipient information. This might be the last name, mail stop, department, building, or company. The characters for the proper address segment are spoken by the operator one at a time into a microphone 109 connected to voice recognition software. The voice recognition software interprets the characters and sends them on to recipient matching software. As each character is received, the matching software narrows down the list of potential recipient matches in the database 22. This continues until a single recipient is identified or no match can be made.

At step S232 a query is made as to whether there is a matching recipient. If the answer to the query at step S232 is no, then the mailpiece 30 is set aside for future disposition at step S234. If the answer to the query of step S232 is yes, the operator is prompted to place the mailpiece 30 onto the feeder 10 (which was set to manual feed at step S218). The mailpiece 30 is fed into the mailpiece sorting apparatus 8 and delivered to the appropriate bin 18 (shown in FIG. 2b) at step S238.

It should be noted that in case where a mailpiece is opened by the operator in order to determine the appropriate addressee, the mailpiece can be handled using various procedures depending upon the condition of the opened packaging or envelope and/or the method implemented by the operator. Some examples of the various procedures include: 1) the operator can hand deliver the mailpiece to the appropriate sort bin; 2) the packaging can be sealed or placed on the mailpiece sorting apparatus in such a manor that the contents will not likely come out of the packaging; and 3) the contents can be put into a new package and a label can be printed for the new package using a label maker (note shown) coupled to the mailpiece sorting apparatus. The appropriate procedure can be determined by one of ordinary skill in the art and can include considering factors such as cost and throughput.

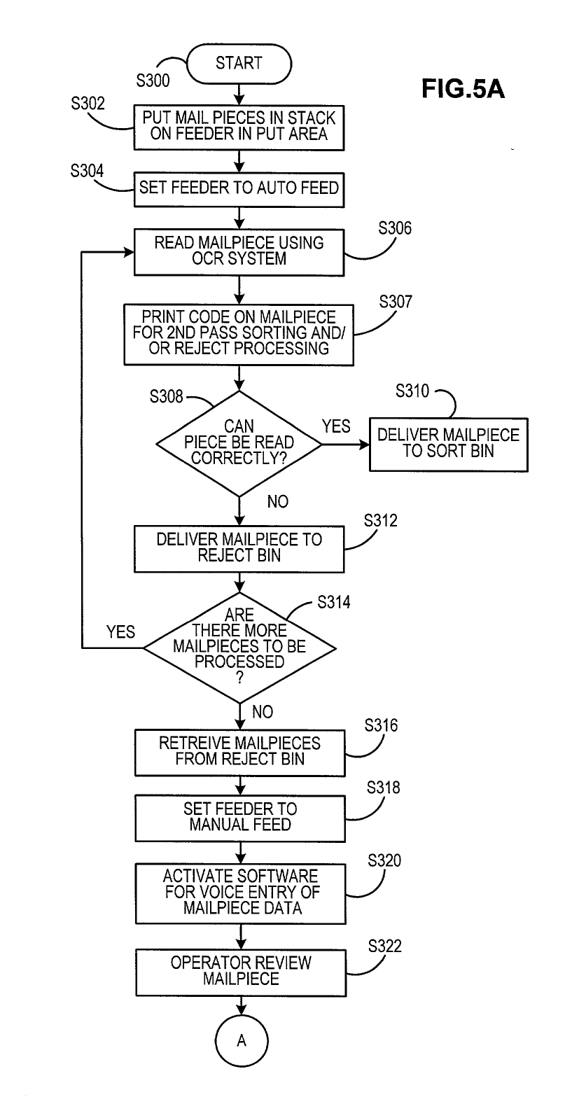

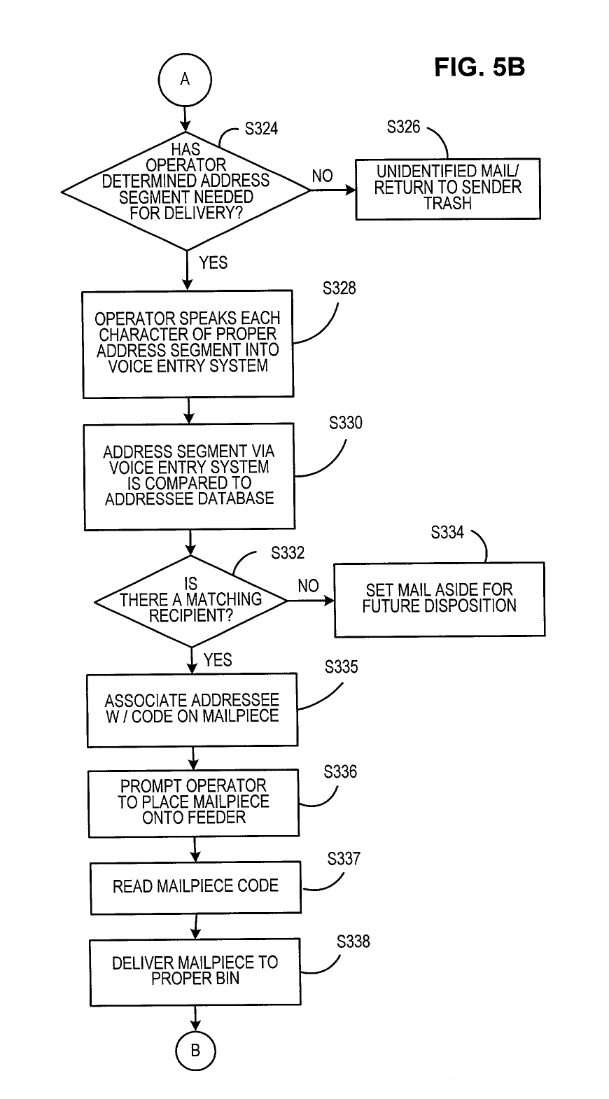

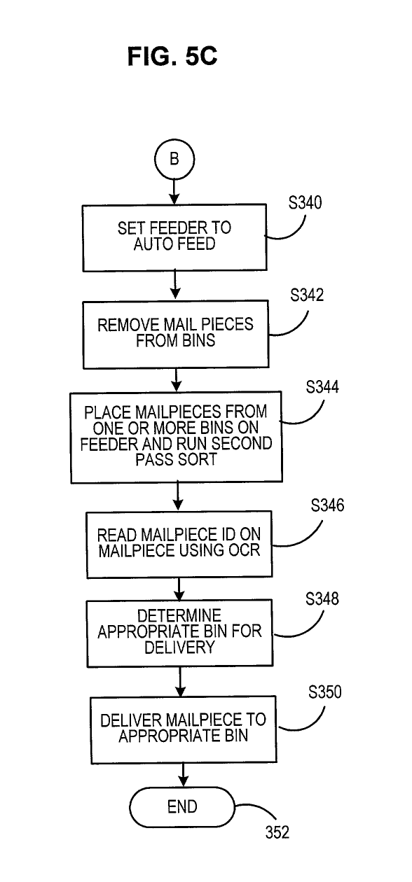

FIGS. 5a-c is a flowchart of an embodiment of the method of processing unreadable mailpieces in a multiple sort pass scenario. At step S300 the method begins. At step S302 a stack of mailpieces (not shown) is placed on the feeder 10 of the mailpiece sorting apparatus 8. At step S304 the feeder 10 is set to auto feed. At step S306 the mailpieces 30 are read using the OCR system. At step 307 a code is printed on the mailpiece 30 for second pass sorting and/or reject processing. At step 308 a query is made as to whether the addressee can be determined from the information read from the mailpiece 30 by the OCR system. If the answer to the query S308 is yes, then the mailpiece 30 is delivered to the appropriate sort bin 18 at step S310. If the answer to the query S308 is no, then the mailpiece 30 is delivered to a reject bin 18′ at step S312. Next, a query is made at step S314 as to whether there are additional mailpiece(s) 30 to be processed. If the answer to the query of step S314 is yes, then steps S306 through S314 are performed until no mailpieces 30 are left to be processed. It the answer to the query at S314 is no, then the process proceeds to step S316 and the mailpieces 30 are retrieved from the reject bin. At steps S318 and S320, the feeder 10 is set to manual feed, and the voice recognition software is activated, respectively. At step S322 the operator reviews mailpieces 30 to determine the appropriate addressee. This step can entail reading the addressee information from the front of the mailpiece 30, opening the envelope to determine the proper addressee or making a researched determination of the addressee by information contained on or within the mailpiece 30. At step S324 a query is made as to whether the operator has determined the address segment needed for delivery. If the response to the query S324 is no, then at step S326 the mailpiece 30 is placed in an area designated for unidentifiable recipient mailpieces 30.

If the response to the query S324 is yes, then the operator speaks addressee information into the voice recognition system of the mailpiece sorting apparatus 8 at S328. The operator may speak a single character at a time or alternately may speak entire words at a time. The input by the operator is dependent upon the technology of the voice recognition software package that is used as explained above in the description of the embodiment of FIGS. 4a-b. The type of voice recognition system used is dependent upon the features desired and the cost of the system. Low cost systems can be obtained for use in conjunction with mail sorting apparatus 8.

Returning to the flow chart of FIGS. 5a-5b, the address segment input into the voice entry system is compared to the addressee database 22 at S330. The type of comparison performed by this step is dependent upon the type of voice recognition system that is being used. For example, if the operator is inputting a single character at a time into the voice system, the system may check for a matching addressee after each character is input. If the operator is inputting entire words at one time, the system may check for a matching addressee after each word is input. As is in the case of a single character input system, the operator picks up a new reject and determines the proper address segment for the recipient information. This might be the last name, mail stop, department, building, or company. The characters for the proper address segment are spoken by the operator one at a time into a microphone 109 connected to voice recognition software. The voice recognition software interprets the characters and sends them on to recipient matching software. As each character is received, the matching software narrows down the list of potential recipient matches in the database 22. This continues until a single recipient is identified or no match can be made.

At step S332 a query is made as to whether there is a matching recipient. If the answer to the query at step S332 is no, then the mailpiece 30 is put aside for future disposition at step S334. If the answer to the query of step S332 is yes, then at step S335 the addressee is associated with the code printed on the mailpiece 30 and at step S336 the operator is prompted to place the mailpiece 30 onto the feeder 10 (which was set to manual feed at step S318). The mailpiece 30 is fed into the mailpiece sorting apparatus 8 and the mailpiece ID is read from the mailpiece 30 at step S337. Based upon the addressee information associated with the mailpiece ID 32 (shown in FIG. 3d), the mailpiece 30 is delivered to the appropriate bin 18 (shown in FIG. 2a) at step S338. At step S340 the feeder 10 is set to automatic feed. At step 342 the mailpieces 30 are removed from the bins. At step S342 the mailpieces 30 which were removed from one or more bins are placed on the feeder 10 for a second pass sort. The determination as to which mailpiece 30 are run through the second pass sort is made by the operator and the equipment in coordination with a previously determined sort scheme which may be determined by one of ordinary skill in the art. At step S346 the OCR reads the mailpiece ID 32 on the mailpieces (the code was printed on the mailpieces during the first pass sort at step S307). At step S348 the mailpiece sorting apparatus 8 determines the appropriate bin for delivery of the mailpiece. At step S350 the mailpiece 30 is delivered to the appropriate bin. The operation continues until all mailpieces are sorted. At step 352, the method ends.

The embodiments described herein can provide the advantages of higher throughput with minimal additional hardware and software costs. Another advantage of the present invention is that it allows for reject processing without need for special typing skills.

The present invention provides for better throughput and decreased sorting costs. While the present invention has been disclosed and described with reference to a single embodiment thereof, it will be apparent, as noted above that variations and modifications may be made therein. It is, thus, intended in the following claims to cover each variation and modification that falls within the true spirit and scope of the present invention.

What is claimed is:

1. A method of sorting mailpieces using a mailpiece sorting apparatus comprising a feeder, an automatic mailpiece reading system and a control system, the method comprising the steps of:
a) providing a voice recognition system coupled to the mailpiece sorting apparatus;
b) obtaining a group of mailpieces that were not automatically readable by the mailpiece sorting apparatus;
c) speaking identifiable addressee segment(s) from a mailpiece in the group of mailpieces that were not automatically readable into the voice recognition system;
d) comparing the spoken identifiable addressee segment(s) from the mailpieces in the group of mailpieces that were not automatically readable to addressee information in the an addressee database of the mailpiece sorting apparatus;
e) if the spoken identifiable addressee segment(s) from the mailpiece in the group of mailpieces that were not automatically readable is matched to the addressee information in the addressee database of the mailpiece sorting apparatus, then delivering the mailpiece to an appropriate bin; and
f) if the spoken identifiable addressee segment(s) from the mailpiece in the group of mailpieces that were not automatically readable is not matched to the addressee information in the addressee database of the mailpiece sorting apparatus, then delivering the mailpiece to a reject bin or container.

2. The method as claimed in claim 1 further comprising the steps of:
g) storing information about the number of mailpieces processed including the number of reject mailpieces processed, the number of mailpieces which were automatically readable and for which the spoken identifiable addressee segments from the mailpiece were matched to the addressee information in the addressee database; and
h) calculating statistical information using the mailpiece sorting apparatus.

3. The method as claimed in claim 1 further comprising the steps of:
g) storing information about the number of mailpieces processed including the number of reject mailpieces processed, the number of mailpieces which were not automatically readable and for which the spoken identifiable addressee segments from the mailpiece were matched to the addressee information in the addressee database; and
h) calculating statistical information using the mailpiece sorting apparatus.

4. A method of sorting mailpieces using a mailpiece sorting apparatus comprising the steps of:
a) automatically reading addressee information from a mailpiece;
b) determining whether an addressee can be determined from the information read from the mailpiece;
c) if the addressee can be determined from the addressee information read from the mailpiece, delivering the mailpiece to an appropriate bin;
d) if the addressee cannot be determined from the addressee information read from the mailpiece, delivering the mailpiece to a reject bin;
e) continuing steps a)-d) until all mailpieces have been read
f) obtaining the mailpieces from the reject bin;
g) humanly reading an identifieable address segment from the mailpiece;
h) speaking the identifiable address segment from the mailpiece into a voice recognition system coupled to the mailpiece sorting apparatus;
i) comparing the identifiable address segment from the mailpiece to an addressee database in order to determine an appropriate bin for delivery;
j) if an appropriate bin for delivery is identified, delivering the mailpiece to the appropriate bin; and
k) if an appropriate bin is not identified, delivering the mailpiece to a reject bin or area.

5. The method as claimed in claim 4 further comprising the steps of;
l) storing information about the number of mailpieces processed including the number of reject mailpieces processed; and
m) calculating statistical information using the mailpiece sorting apparatus.

6. An mailpiece sorting apparatus for processing reject mailpieces, the mailpiece sorting apparatus configured to processes a stack of mailpieces along a feed path and reading each mailpiece from the stack of mailpieces as each mailpiece travels along the feed path and through an OCR station, the mailpiece sorting apparatus further configured for processing individual reject mailpieces for which the addressee
a feed station for feeding and separating the stack of mail;
two or more bins for receiving mailpieces after the mailpieces travel along the feed path;
the OCR station for reading addressee information from the mailpieces as they are moved along the feed path and interpreting addressee information;
a software system and database for identifying the addressee and determining an appropriate delivery bin from the two or more bins for receiving the mailpieces;
a voice recognition system for inputting address information that was unidentifiable by the OCR station; and
whereby if humanly identifiable information is available from the mailpiece that was unidentifiable by the OCR station, an operator inputs the humanly identifiable addressee information from the mailpiece into the voice recognition system so that the mailpiece can be delivered to the appropriate delivery bin from the two or more bins for receiving the mailpieces.
